(19) United States
(12) Patent Application Publication
(10) Pub. No.: US 2021/0150323 A1
(43) Pub. Date: May 20, 2021

(54) METHODS AND APPARATUS TO IMPLEMENT A NEURAL NETWORK

(71) Applicant: Intel Corporation, Santa Clara, CA (US)

(72) Inventors: Javier Sebastian Turek, Beaverton, OR (US); Ignacio J. Alvarez, Portland, OR (US); David Israel Gonzalez Aguirre, Hillsboro, OR (US); Javier Felip Leon, Hillsboro, OR (US); Maria Soledad Elli, Hillsboro, OR (US)

(21) Appl. No.: 17/133,181

(22) Filed: Dec. 23, 2020

(51) Int. Cl. G06N 3/063; G06F 7/544

(52) U.S. Cl. CPC G06N 3/063; G06F 7/5443

(57) ABSTRACT

Methods, apparatus, systems and articles of manufacture are disclosed to implement a neural network. An apparatus to implement a neural network, the apparatus comprising memory formed on a substrate, neural network inference logic formed on the same substrate as the memory, the neural network inference logic to load a plurality of neural network parameters in a multiply-accumulate register, and perform a sample-multiply-add operation on the neural network parameter values and input data to generate a neural network inference result, and a memory controller to transfer the neural network inference result to at least one of a host memory external to the substrate or a host processor external to the substrate.

### FIELD OF THE DISCLOSURE

This disclosure relates generally to artificial intelligence computing systems, and, more particularly, to methods and apparatus to implement a neural network.

### BACKGROUND

In recent years, computers have implemented neural networks in decision making. In general, feed-forward neural networks move information forward through the network. The information starts at the input layer, travels to any hidden layers, and then arrives at the output layer. A feed-forward neural network executes the forward information flow by multiplying input data from a node with the importance or weight of the data. Using various methods, the neural network sends the important data to the next hidden layer. One of these types of feed-forward neural networks is the Bayesian neural network. The Bayesian neural network is a model that determines the weights through a probability distribution. Bayesian neural networks use probability distributions to determine the weights because the user (e.g., programmer, scientist, developer) does not know the inherent importance of the data of an input node when creating the neural network, and therefore is guessing when assigning the weight as a simple fixed scalar in the neural network. Using a probability distribution of all the possible weights and randomly selecting a weight creates a different network each time the network is run. Running the network multiple times and comparing the output with the target result allows the user to reduce uncertainty of the output by obtaining a result that is more accurate.

In recent years, computers have executed machine-readable instructions through the use of a processor. The processor executes an instruction by retrieving the instruction from memory, using an arithmetic logic unit to perform the operation, and then transferring the result back to memory.

### BRIEF DESCRIPTION OF THE DRAWINGS

FIG. 1A is an example Bayesian neural network.

FIG. 1B is an illustrative representation of an example random sampling process executed by the example Bayesian neural network of FIG. 1A.

FIG. 2 is a system diagram and process flow of a prior technique to implement a Bayesian neural network.

FIG. 3 is a block diagram of an example compute device including Bayesian Neural Network (BNN) inference logic in a memory device and/or a data storage device in accordance with teachings of this disclosure.

FIG. 4 is an example apparatus implementing memory and media access circuitry including the BNN inference logic of FIG. 3 formed on the same semiconductor substrate.

FIG. 5 is an example configuration of the memory cells and media access circuitry of FIG. 3 included in the apparatus of FIG. 4.

FIG. 6 is an example configuration of the memory cells of FIGS. 3 and 5 implemented using 3D cross-point memory.

FIG. 7 is an example implementation of the BNN inference logic of FIG. 3.

FIG. 8-10 are schematic illustrations of example daughter boards that may be used to implement the media access circuitry, the memory, and/or the memory controller of FIG. 3 separate from a host central processing unit (CPU).

FIG. 11 is an example system diagram and process flow of the example apparatus of FIG. 3.

FIG. 12 is a flowchart representative of example machine-readable instructions which may be executed to implement the apparatus of FIG. 3 to implement a Bayesian neural network in accordance with teachings of this disclosure.

FIG. 13 is another flowchart representative of example machine-readable instructions which may be executed to also implement the apparatus of FIG. 3 to implement a Bayesian neural network in accordance with teachings of this disclosure.

FIG. 14 is yet another flowchart representative of example machine-readable instructions which may be executed to implement the apparatus of FIG. 3 to implement a Bayesian neural network in accordance with teachings of this disclosure.

FIG. 15 is a block diagram of an example processing platform structured to execute the instructions of FIGS. 12, 13, and/or 14 to implement the apparatus of FIG. 3.

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another. Notwithstanding the foregoing, in the case of a semiconductor device, “above” is not with reference to Earth, but instead is with reference to a bulk region of a base semiconductor substrate (e.g., a semiconductor wafer) on which components of an integrated circuit are formed. Specifically, as used herein, a first component of an integrated circuit is “above” a second component when the first component is farther away from the bulk region of the semiconductor substrate than the second component. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second.

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, a Bayesian neural network model is used. Example disclosed herein may be used to implement a Bayesian neural network model by random sampling weight parameters in an inference phase.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using standard methods such as stochastic gradient descent. However, any other training algorithm may additionally or alternatively be used. In examples disclosed herein, training is performed until a target accuracy is satisfied. Training is performed using hyperparameters that control how the learning is performed (e.g., a learning rate, a number of layers to be used in the machine learning model, etc.). Training is performed using training data.

Once training is complete, the model is deployed for use as an executable construct that processes an input and provides an output based on the network of nodes and connections defined in the model. In some disclosed examples, the model is stored in memory and is accessible by media access circuitry formed on the same semiconductor substrate as the memory. In other examples, the model is transferred from a central processing unit and/or a memory controller to memory accessible by media access circuitry formed on the same semiconductor substrate as the memory. The model may then be executed by Bayesian neural network logic inside media access circuitry. Although disclosed examples are described in connection with Bayesian neural networks, examples may be used with any type of neural network.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, the inference phase is run multiple times, as each time a different weight is utilized in processing the input data. In some examples, the different weight is randomly sampled from a probability distribution of the possible weights. In some examples, the inference phase is run at least twenty times or until a target accuracy is achieved. In some examples, the Bayesian neural network is able to generate a probability density function at the output which enables the computation of confidence intervals of the resultant output. In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

Prior Bayesian neural networks are resource intensive as each time the Bayesian neural network is executed, the weight for each neuron must be sampled. The weights of a Bayesian neural network are not fixed scalars that can be set once. The parameters that describe the probability distributions of the weights are stored in memory and must be accessed by the processor. This significantly increases the required memory bandwidth to access weights in memory, creating a bottleneck that caps the speed of the Bayesian neural network inference.

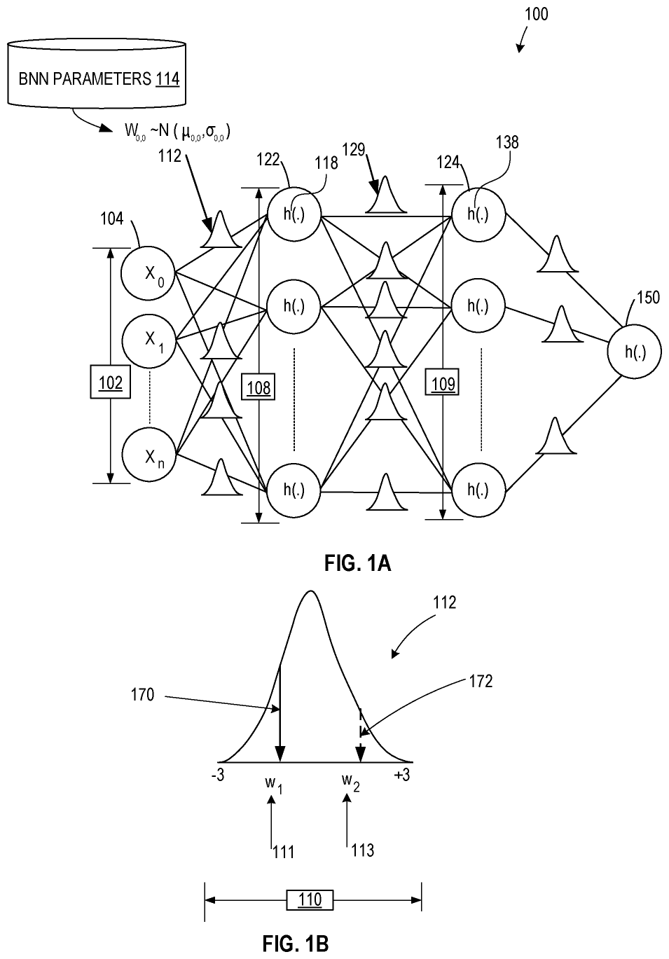

FIG. 1A is an illustration of an example Bayesian neural network (BNN) 100. In this example, the example Bayesian neural network 100 has already been trained and is ready for inference to begin. The example training process defines probability distributions of weights to be used at nodes (e.g., neurons) of the example Bayesian neural network 100 in the inference process. For example, different ones of the nodes of the Bayesian neural network 100 are assigned separate probability distributions. Each probability distribution includes a corresponding plurality of weights. As such, during an inference phase, multiple inference iterations on input data can be performed using the example Bayesian neural network 100. During each inference iteration, different ones of the weights can be selected or sampled at each node from the probability distributions of the Bayesian neural network 100. The selected or sampled weights are applied to data at each node as described below to generate a result value of the Bayesian neural network 100 that identifies the input data and an associated uncertainty value indicative of the likelihood that the result is correct. To achieve higher certainties that the result value actually identifies the input data, multiple inference iterations are performed using the Bayesian neural network 100, each time selecting or sampling a different combination of weights at the multiple nodes to produce another result value. In some examples, the Bayesian neural network 100 (e.g., the previous Bayesian neural network) is discarded. Any number of subsequent inference iterations can be performed until a target number of iterations is reached and/or a target uncertainty value is achieved.

The inference process of the example Bayesian neural network 100 of FIG. 1A begins with example input data 102 fed into an example first hidden layer 108. The example input data 102 is represented by x₀, x₁, and xₙ notation for any number of n input data values. Data values of the input data 102 may be from images (e.g., pixel data), audio data, sensor data, and/or any other data for which neural network recognition is to be performed. An example instance of the example input data 102 is input data value 104 represented by xo. The example Bayesian neural network 100 is a deterministic neural network in which sampled weights are applied to input data. For example, to feed multiple values (e.g., elements) of the example input data 102 forward through the example Bayesian neural network 100 to the example first hidden layer 108 values of the example input data 102 are multiplied by example sampled weights and are then processed at example hidden neurons 122 which use element-wise non-linear activation functions 118 (e.g., h(.)).

FIG. 1B is an illustration of the example random sampling process executed by the example Bayesian neural network 100 of FIG. 1A. FIG. 1B illustrates an example weight selection process that can be implemented to select (e.g., sample) weight values for the example input data 102 before the example first hidden layer 108. In examples disclosed herein, a weight value controls how much a data value (e.g., example input data value 104) affects the resulting output of a hidden neuron. That is, a weight's value can emphasize or de-emphasize the effect of an input data value on a neuron's output value. A user (e.g., a programmer, a scientist, a developer) of the example Bayesian neural network 100 does not know how much weight or emphasis should be attributed to data at the example hidden neurons of the example hidden layers (e.g., a first hidden layer 108 or a second hidden layer 109). However, an example probability distribution 112 of possible weights 110 can be used to randomly select a weight value 111. Selected or sampled ones of the example unsampled weights 110 are randomly selected or sampled and are referred to herein as example sampled weights 111 (e.g., selected weights). The example probability distribution 112 of all the unsampled weights 110 is created from example Bayesian neural network parameters 114 that describe the example probability distribution 112 such as the example center location parameter, the example uncertainty parameter, and the example scale parameter. The example center location parameter is the x-value where the center of the probability distribution 112 occurs. In some examples, the example center location parameter is the mean or the average of prior inference results. The example uncertainty parameter and the example scale parameter are used to define the shape, range or spread of the probability distribution 112. The example Bayesian neural network parameters 114 can be defined (e.g., discovered, selected, chosen) in the training phase of the example Bayesian neural network 100 prior to the inference phase. In some examples, the example Bayesian neural network parameters 114 are randomly sampled (e.g., randomly drawn). In the example of FIG. 1B, the probability distribution 112 of all the possible unsampled weights 110 spans the range from negative three (−3) to positive three (+3). In other examples, the probability distribution 112 of all the possible unsampled weights 110 is not constrained and can span the range from negative infinity to positive infinity. When the unsampled weights 110 are sampled for a first inference iteration, the sampled weight 111 (w₁) is referred to herein as first iteration sampled weight 111. The example first iteration sampled weight 111 (w₁) is approximately −1.9 as represented by the solid arrow line generally referenced by reference numeral 170. On the next inference iteration with the same example input data value 104 (e.g., a second inference iteration during a second time at which the unsampled weights 110 are sampled), the second iteration sampled weight 113 (w₂) is approximately +2.7 as represented by the dashed arrow line generally referenced by reference numeral 172. In other examples, other possible weight values at any other positions of the probability distribution 112 could be selected or randomly sampled. Although FIG. 1B shows two sample weights 111, 113 corresponding to two separate inference iterations, such a weight sampling process can be performed for any number of inference iterations. In this manner, during the multiple inference iterations different weight values can be selected or sampled based on the respective probability distributions of the multiple nodes of the example Bayesian neural network 100.

Returning to FIG. 1A, after the example first iteration sampled weights 111 (FIG. 1B) are randomly selected (e.g., sampled, drawn) from the example probability distribution 112 of the example unsampled weights 110 (FIG. 1B) the example input data 102 is multiplied by the example first iteration sampled weights 111 to generate product values to be processed by neurons for ones of the example first hidden layer 108. For each example hidden neuron of the example hidden layer 108, an example element-wise non-linear activation function 118 (e.g., sigmoid function, tanh function, ReLU function) is performed on the product of the corresponding example input data 102 and the corresponding example sampled weight. The example element-wise non-linear activation function 118 mathematically transforms (e.g., scales, normalizes, maps) the product into a value between a specified range. For example, a sigmoid function 118 may transform the product into a value bounded between negative one (−1) and positive one (+1). After being transformed by the example element-wise activation function, the transformed product (e.g., an example first transformed product, also referred to as inter-node data, inter-neuron data, or hidden layer data) is sent to the next hidden layer (e.g., a second hidden layer 109).

Continuing with the first iteration of the example Bayesian neural network inference, the process proceeds to the example second hidden layer 109 at which a similar process occurs as previously described for the example first hidden layer 108. Another realization (e.g., sampling) of an example probability distribution 129 of unsampled weights for the example hidden neuron 124 of the example second hidden layer 109 occurs to obtain a sampled weight from the example probability distribution 129. The sampled weight is then multiplied by the example hidden layer data (e.g., the example first transformed product of the example first hidden layer 108) to create a second product. An example element-wise non-linear activation function 138 (e.g., sigmoid, tanh, ReLUs) of the corresponding example hidden neuron 124 is performed on the example second product generating an example second transformed product which is sent to the next hidden layer. In the example of FIG. 1A, there are two hidden layers, but any number of hidden layers can be used to implement a Bayesian neural network 100 in accordance with teachings of this disclosure. After propagating through the last hidden layer, the example resultant output data is generated at an example output neuron 150 of the example Bayesian neural network 100. In the example of FIG. 1A, there is one output neuron 150. However, examples disclosed herein may be used to implement Bayesian neural networks with any number of output neurons.

The example resultant output data is the example iteration result of the example Bayesian neural network 100. The example resultant output data is dependent on the type of problem the example Bayesian neural network 100 is designed to solve. For example, a regression problem such as predicting a median house value may result in a numerical answer such as $285,000 dollars for the example resultant output data. For example, a classification problem such as identifying images from three classes (e.g., types) of animals may result in a vector of length three, where each value in the vector represents an associated probability that the image represents the respective animal. For example, if the example input data 102 represents pixels of images of cats, dogs, or rabbits during a training phase, a resultant vector of [60,20,20] may be generated, signifying there is a sixty percent chance the image is of a first class (e.g., cat), a twenty percent chance the image is of a second class (e.g., dog), and a twenty percent chance the image is of a third class (e.g., rabbit). In some examples, the example resultant vector is called a probability density function showing the example probability of the example classes. The entire inference process of the example Bayesian neural network 100 may be executed a set number of times or a minimum number of times (e.g., at least twenty times) or until a target accuracy is satisfied, with the same example input data 102. In some examples, the example iteration results are typically aggregated with the example iteration results of previous iterations of the example Bayesian neural network 100. The example aggregation is used to average the iteration results into an example single aggregated result referred to as a confidence interval. For example, in the example median house value estimate, for the same input data 102, there may be twenty iterations generating values such as $285,000, $291,000, $268,000, etc. Results from the example twenty iterations may be aggregated to produce an example single aggregated result. A confidence interval may be expressed in the form of <final result>+/−<uncertainty value> such as $285,000 (final result) +/−$5,000 (uncertainty value). The uncertainty value is based on the target confidence interval and is computed based on the input data and the target user confidence interval. In some examples, the user receives the example single aggregated result and does not receive the multiple example iteration results used to generate the aggregated result. In other examples, the user receives the single aggregated result and corresponding confidence interval. The example confidence intervals enable continuous decisions with associated likelihood not available with only a result.

The topology of the Bayesian neural network 100 of FIG. 1A can be described by a pipeline description (e.g., the number of hidden layers, the number of input nodes/neurons, the probability distribution functions of the weights). For example, the pipeline description can be described using the example Bayesian neural network parameters 114 of FIG. 1. The example input data location is the place where the example input data 102 of FIG. 1 is stored while not being utilized. An example data location could be a flash drive. The example output data location is the place where the results of the Bayesian neural network inference are stored. An example output location could be a solid state drive (SSD).

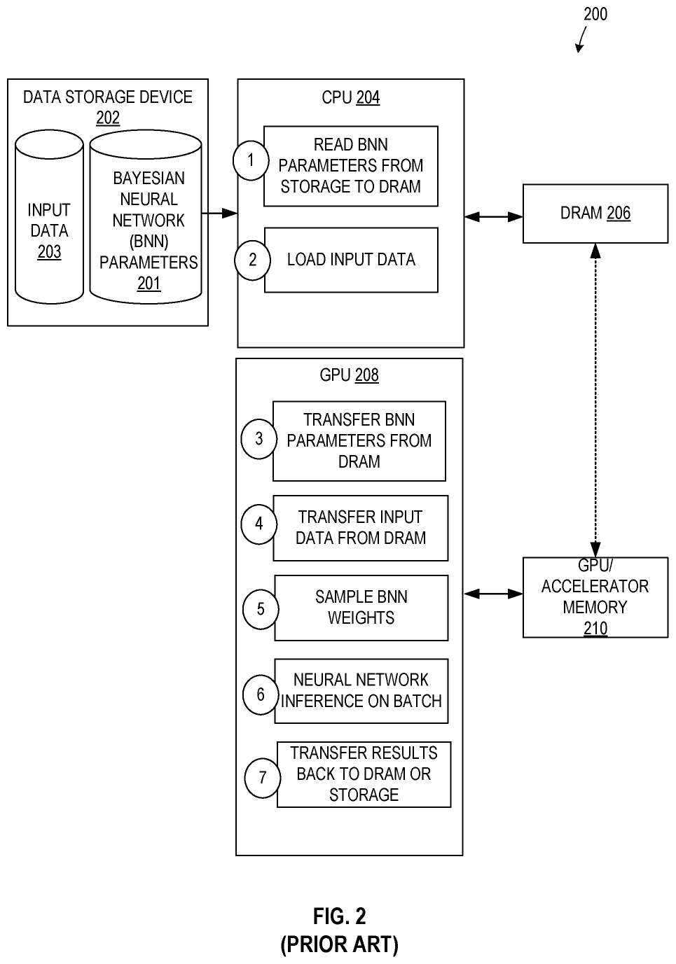

FIG. 2 is a diagram of a process flow of a prior technique to implement a Bayesian neural network in a computer system 200. FIG. 2 shows operations enumerated 1 through 7 occurring in different components (e.g., sections, locations) of the computer system 200. Bayesian neural network parameters 201 are stored in a data storage device 202. In some examples, the Bayesian neural network parameters 201 are several gigabytes. A central processing unit (CPU) 204 retrieves the Bayesian neural network parameters 201 from the data storage device 202 and sends the Bayesian neural network parameters 201 to host Dynamic Random Access Memory (DRAM) 206 in enumerated operation 1.

In enumerated operation 2, the CPU 204 loads the input data 203 from the data storage device 202 or a network interface device (not shown) to the host DRAM 206. The computer system 200 implements the Bayesian neural network in a graphical processing unit (GPU) 208 or an accelerator 208. Bayesian neural network parameters 201 can be several gigabytes, requiring more memory than the GPU 208 or accelerator 208 is able to provide.

Enumerated operation 3 includes transferring the Bayesian neural network parameters 201 from the host DRAM 206 to the memory 210 of the GPU 208.

Enumerated operation 4 includes transferring the input data 102 from the host DRAM 206 to the memory 210 of the GPU 208.

At enumerated operation 5, the GPU 208 samples weights from a probability distribution generated based on the Bayesian neural network parameters 201. The sampled weights are assigned to corresponding neurons of the Bayesian neural network. The sampled weights are stored in memory 210.

In enumerated operation 6, the GPU 208 performs an inference process on the input data 203. The GPU 208 accesses the stored sampled weights in the GPU memory 210 before multiplying the stored sampled weights with input data. The Bayesian neural network may be executed multiple times (e.g., twenty or any other number) until a target accuracy is satisfied, which may involve multiple samplings of unsampled weights of the probability distribution and multiple inferences on the input data 203. Each execution of the Bayesian neural network uses a unique sampling of the weights, which involves performing a significant number of memory transactions between the CPU 204, the host DRAM 206, the GPU/accelerator memory 210 and the GPU 208. In some prior techniques, the samplings of the weights are stored in the GPU/accelerator memory 210 for the entire inference process or the intermediate results are stored in the GPU/accelerator memory 210. In some prior techniques, the Bayesian neural network parameters 201 are continuously transferred to the CPU 204 for use in matrix multiplication. The prior art techniques are computationally complex and have reduced parallelization capabilities due to the nature of the workflow. In some prior techniques, the lack of speed (e.g., reduced effective speed) when executing a Bayesian neural network determines that the Bayesian neural network is unable to be performed in embedded devices or datacenters.

In enumerated operation 7, the results are aggregated together and sent to data storage device 202. The results for each iteration are aggregated together to build a single aggregated result (e.g., a single confidence interval) and then transferred to the host DRAM 206 or to data storage device 202 in enumerated operation 7.In some prior techniques, the results for each iteration are aggregated into a single aggregated result which includes a probability density function at the output.

The prior art implementation shown in FIG. 2 has a speed of operation that is limited by the speed of data accesses across busses between the CPU 204 and the host DRAM 206, and between the GPU 208 and the GPU/accelerator memory 210. As such, the multiple memory accesses to perform the calculations using prior techniques in the Bayesian neural network are time-inefficient and power-inefficient because of the bus-based memory accesses.

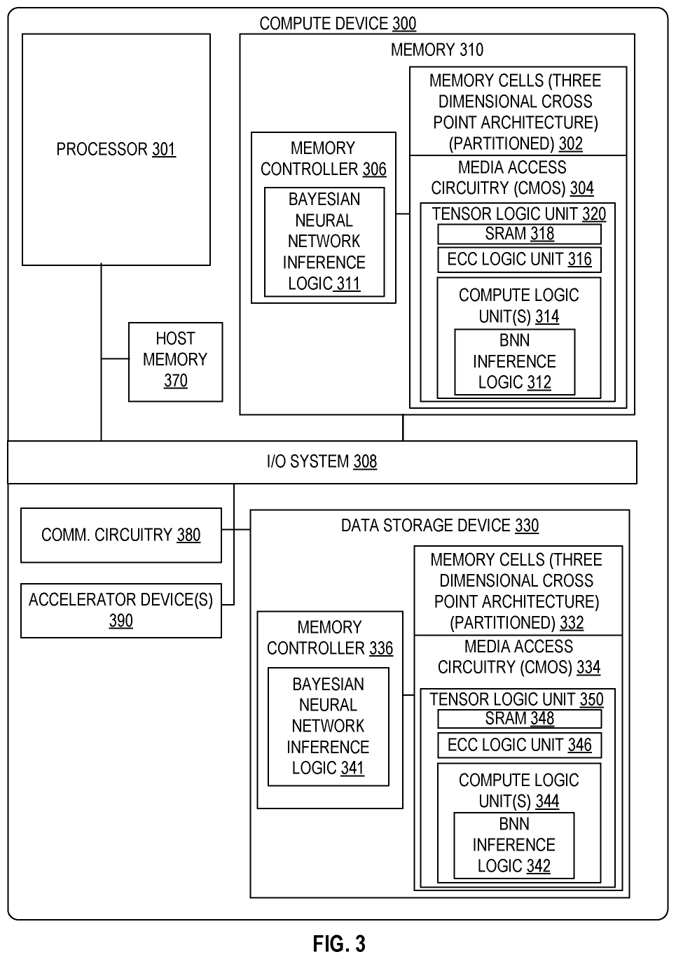

FIG. 3 is a block diagram of an example compute device 300 including Bayesian Neural Network (BNN) inference logic to implement Bayesian neural networks in accordance with teachings of this disclosure. The example compute device 300 includes an example processor 301 (e.g., an example host processor, a central processing unit (CPU), an example graphics processing unit (GPU), etc.), example memory 310, an example data storage device 330, example communication circuitry 380, and example accelerator device(s) 390. The example processor 301 is generally configured to execute machine-readable instructions and run programs. The example communication circuitry 380 is generally configured to transmit information from the example compute device 300 and/or receive information at the compute device 300 via, for example, a network. The example accelerator device(s) 390 are generally configured to implement data processing operations through hardware acceleration. The example memory 310 is generally configured to store data such as Bayesian neural network parameters and input data to implement Bayesian neural networks. The example memory 310 includes example memory cells 302, an example memory controller 306, and example media access circuitry 304. The example data storage device 330 is generally configured as an alternate location (e.g., long-term storage) to store information that may be used to implement Bayesian neural networks. In examples disclosed herein, the example memory 310 and the example data storage device 330 can be implemented using the same type of data storing technology such as three-dimensional (3D) cross-point memory (e.g., Intel Optane® memory) or any other suitable memory. However, the storing technology is used as short-term system memory in the case of the example memory 310, and the storing technology is used as long-term storage in the case of the example data storage device 330. In some examples disclosed herein, Bayesian neural networks are implemented using data in the example memory 310. In other examples, Bayesian neural networks are implemented using data in the example data storage device 330. In yet other examples, Bayesian neural networks are implemented using data in both the example memory 310 and the example data storage 330. The example data storage device 330 includes example memory cells 332, an example memory controller 336, and example media access circuitry 334. The example memory cells 332 are substantially similar or identical to the example memory cells 302, the example media access circuitry 334 is substantially similar or identical to the example media access circuitry 304, and the example memory controller 336 is substantially similar or identical to the example memory controller 306.

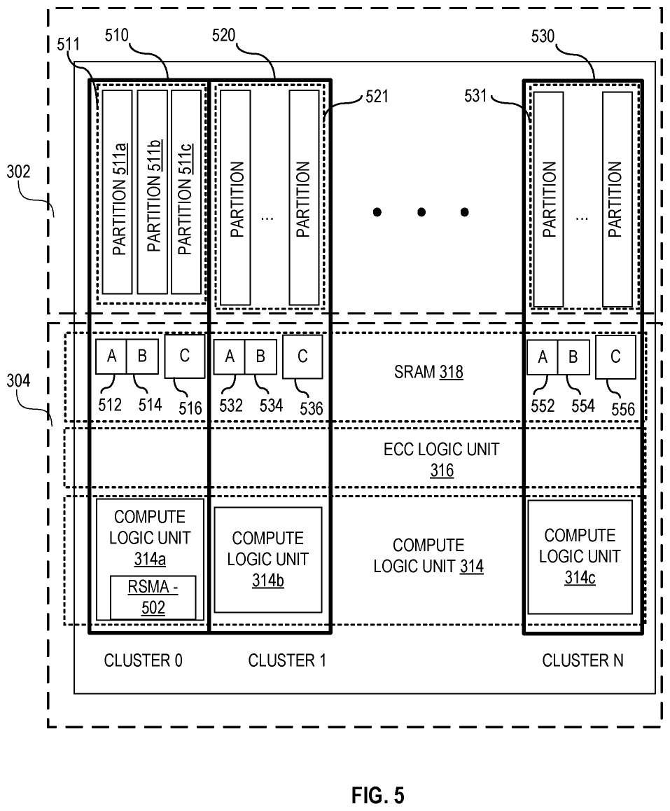

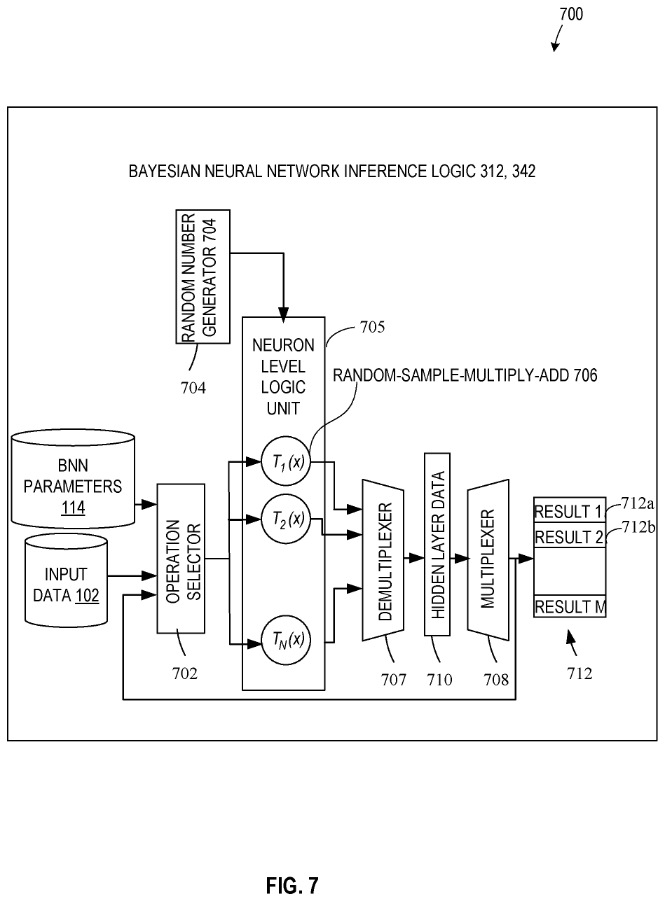

Turning in detail to the example memory 310, the example memory controller 306 includes example Bayesian neural network inference logic 311. In some examples, the Bayesian neural network inference logic 311 of the memory controller 306 is configured to setup the BNN by controlling memory operations to copy BNN parameter values and input data from the memory cells 302 to the Bayesian neural network inference logic 312 to setup the BNN, and the Bayesian neural network inference logic 312 is configured to execute the BNN inference operations based on the BNN parameters and input data. In other examples, the Bayesian neural network inference logic 311 in the memory controller 306 is configured to both setup the BNN and execute the BNN inference operations. In either case, the Bayesian neural network inference logic 311 and/or the Bayesian neural network inference logic 312 execute the BNN inference operations using an example BNN inference pipeline (discussed in connection with FIG. 7). The example media access circuitry 304 includes a tensor logic unit 320 which includes a compute logic unit 314 which includes example Bayesian neural network inference logic 312. In the illustrated example, the example Bayesian neural network inference logic 312 includes sample-multiply-accumulate logic (e.g., random-sample-multiply-accumulate (RSMA) logic 502 of FIG. 5) to perform random-sample-multiply-add operations. Additionally or alternatively, the example Bayesian neural network inference logic 311 contains the same or similar sample-multiply-accumulate logic of the example Bayesian neural network inference logic 312. In yet other examples, the example Bayesian neural network inference logic 312 is configured to setup and execute an example BNN inference pipeline, and the Bayesian neural network inference logic 311 is omitted from the memory controller 306. The Bayesian neural network inference logic 341, 342 of the data storage device 330 may be implemented in similar configurations as described above for the Bayesian neural network inference logic 311, 312.

The example memory cells 302 are generally configured to store example single aggregated results of the inference calculations. In some examples, the example memory cells 302 store the example Bayesian neural network parameters 114 prior to loading the example Bayesian neural network parameters to a multiply-accumulate register. The example memory cells 302 (and the example memory cells 332) are generally configured as an intermediate memory to quickly access data used to generate the BNN. The example media access circuitry 304 includes an example tensor logic unit 320 generally configured to run matrix calculations and example Bayesian neural network inference logic 312 generally configured to perform a random-sample-multiply-add operation utilized in an example BNN inference pipeline. In some examples, the example media access circuitry 304 is configured to access a command from the example host processor 301. In such examples, the command causes the example media access circuitry 304 to initiate the example BNN inference pipeline. In other examples, the example media access circuitry 304 is able to use the example Bayesian neural network inference logic 311, 312, 341, 342 to generate the Bayesian neural network inference result based on generating a plurality of hidden layer data in the example local memory (e.g., the example static random-access memory (SRAM) 318), and providing the plurality of hidden layer data through the Bayesian neural network pipeline, until an inference result of the Bayesian neural network 100 is generated. In yet other examples, the example media access circuitry 304 is configured to perform matrix calculations and element-wise non-linear activation functions on the input data and the plurality of sampled Bayesian neural network weights to perform the Bayesian neural network inference.

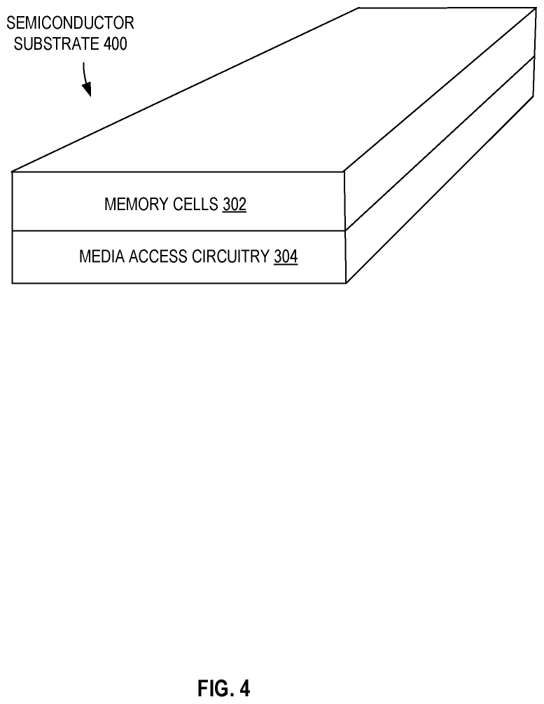

The example tensor logic unit 320 includes an example compute logic unit 314, an example error correction logic unit 316 (e.g., error-correcting code (ECC) logic) and example static random-access memory (SRAM) 318. In some examples, the example memory cells 302 and the example media access circuitry 304 are formed on a single semiconductor substrate as shown in FIG. 4.

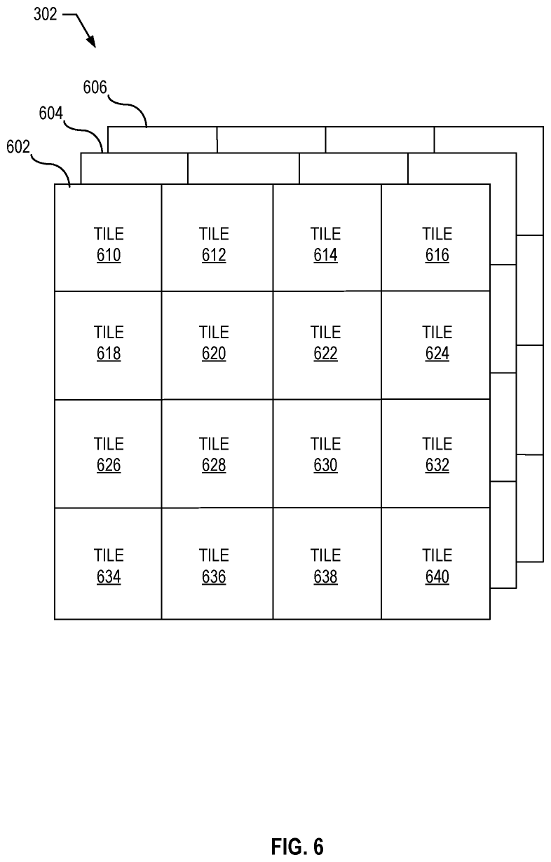

FIG. 4 illustrates an example semiconductor substrate 400 (e.g., a semiconductor die) including the example memory cells 302 and the example media access circuitry 304 of FIG. 3. Example non-volatile memory (e.g., as far memory in a two-level memory scheme and/or as a component of a data storage device) that may be used to implement the example memory cells 302 includes 3D cross-point memory technology (e.g., Intel Optane® memory) (further described in FIG. 6). In the illustrated example, the media access circuitry 304 is an integrated circuitry constructed from complementary metal-oxide-semiconductors (CMOS) as a layer under or on the example memory cells 302. The example memory cells 302 are able to store the example Bayesian neural network parameters prior to loading the example Bayesian neural network parameters to the example media access circuitry 304. The output of the media access circuitry 304, wherein the output of the media access circuitry 304 may be the example single aggregated result (e.g., a confidence interval) or iteration results. The example media access circuitry 304 is able to perform calculations by accessing input data stored on the example memory cells 302 by performing intra-substrate data accesses (e.g., reads and/or writes) within the semiconductor substrate 400 without requiring external (e.g., off-chip or off-die) reads and/or writes to a host memory DRAM or a GPU to access data for the calculations.

FIG. 5 is an example implementation of the memory cells 302 and the media access circuitry 304 of FIG. 3. FIG. 5 shows in detail the communication (e.g., data flow) between the example media access circuitry 304 and the example memory cells 302. In the example of FIG. 5, the example memory cells 302 and example media access circuitry 304 are shown partitioned (e.g., divided) into example clusters 510, 520, 530. In the example of FIG. 5 only three clusters are shown (e.g., the clusters 510, 520, and 530). However, any number of clusters with a similar layout can be included in other examples. The example cluster 510 includes multiple example memory partitions 511a, 511b, and 511c (also called the set of partitions 511), the example SRAM 318 of FIG. 3, an example error correction logic unit 316 of FIG. 3, and an example compute logic unit 314a of the compute logic units 314 of FIG. 3. The example cluster 520 and the example cluster 530 have similar components and function similar to the example cluster 510. The example set of partitions 521 and the example set of partitions 531 have similar components and function similar to the example set of partitions 511. The example memory partitions 511a, 511b, and 511c, are generally configured to store bit-level data. The example SRAM 318 further includes example scratchpads 512, 514, and 516 which are generally configured to store values of matrices.

Example cluster 510 utilizes the example compute logic unit 314a to read an example first subset of matrix data (e.g., matrix A) from the set of partitions 511 and provide the example first subset of matrix data to the example error correction logic unit 316. The example compute logic unit 314a includes example random-sample-multiply-accumulate (RSMA) logic 502. In examples disclosed herein, the RSMA logic 502 is implemented by the BNN inference logic 312 (FIG. 3). The example error correction logic unit 316 is able to correct errors in the example first subset of matrix data and broadcast changes to the corresponding example scratchpads 532, 552 in the other example clusters 520 and/or 530. The example first subset of matrix data is then accepted at a first example scratchpad 512 (e.g., an operation data register 512). The example operation data register 512 accepts input data 102 (FIG. 1) or multiplied products depending on the current step of the process of the execution of the example Bayesian neural network 100. The example compute logic unit 314a activates the example RSMA logic 502 which has access to Bayesian neural network parameters 114 (FIG. 1) such as the Bayesian neural network probability distribution center location and uncertainty which describe the probability distribution 112 from which weights will be sampled. The example RSMA logic 502 reads the Bayesian neural network parameters that describe the weights from a second example scratchpad 514 (e.g., a multiply-accumulate register 514). The example RSMA logic 502 randomly-samples for the weights based on the Bayesian neural network parameters that are loaded in the example multiply-accumulate register 514. The RSMA logic 502 multiplies the sampled weight with the input data stored/loaded at the example operation data register 512, and using a matrix-multiply operation and accumulates (e.g., adds) the data (e.g., input data 102 or multiplied products, transformed products from a previous hidden layer) in the example operation data register 512 and the example sampled weight in the multiply-accumulate register 514 resulting in matrix C stored at a third example scratchpad 516 (e.g., an output register 516). The example scratchpads 512 and 514 are able to perform matrix calculations (e.g., matrix multiply and accumulate) on the example first subset of matrix data (e.g., matrix A) and the example second subset of matrix data (matrix B) resulting in output data (e.g., matrix C) stored in example output register 516. The example output data may be used in further matrix calculations, before being stored in the set of partitions 511 (e.g., partition 511c). The example of FIG. 5 shows how the matrix calculations can occur concurrently as the example scratchpads 512, 514, 516 can multiply a first portion of two matrices, while the scratchpads 532, 534, and 536 of cluster 520 concurrently multiply a second portion of the same two matrices resulting in output data stored at example scratchpad 536. In some examples, the example scratchpads 552, 554, 556 function similar to the example scratchpads 532, 534, 536. In some examples, the RSMA logic 502 samples for the weight and applies that weight to matrix B of the second cluster 520 and apply the weight to matrix B of the example cluster 530. In such examples, the example A matrices are all different subsets of matrix data. In other examples, the example A matrices include the same portion of data, and the example RSMA logic 502 samples unique weights for the matrices B.

FIG. 6 illustrates an example tile architecture that may be used to implement the memory cells 302 of FIG. 3. The example tile architecture is also referred to herein as a cross-point architecture (e.g., an architecture in which memory cells sit at the intersection of word lines and bit lines and are individually addressable and in which bit storage is based on a change in bulk resistance), in which each example memory cell (e.g., tile) 610, 612, 614, 616, 618, 620, 622, 624, 626, 628, 630, 632, 634, 636, 638, 640 is addressable by an example x parameter and an example y parameter (e.g., a column and a row). The example memory cells 302 includes multiple partitions, each of which includes the tile architecture. The partitions may be stacked as layers 602, 604, 606 to form a three-dimensional cross-point architecture (e.g., a 3D cross-point (XPoint) memory such as Intel Optane® memory). Unlike typical memory devices, in which only fixed-size multiple-bit data structures (e.g., bytes, words, etc.) are addressable, the example media access circuitry is configured to read individual bits, or other units of data, from the memory cells 302 at the request of the example memory controller, which may produce the request in response to receiving a corresponding request from the processor. In some examples, the 3D cross-point memory technology (e.g., Intel Optane® memory) is able to significantly increase the parallelization capabilities of an example processor 301 (FIG. 3). In some examples, the 3D cross-point memory technology (e.g., Intel Optane® memory) is used in non-volatile storage applications data platform applications, and Internet of Things applications including data center applications and M2 memory applications such as autonomous vehicles or robotic applications.

FIG. 7 is an example BNN inference pipeline 700 that may be used to implement the example Bayesian neural network inference logic 311, 312, 341, 342 of FIG. 3. In some examples, the example BNN inference pipeline 700 is implemented by the example memory controller 306, 336. In some examples, the example BNN inference pipeline 700 is implemented by the example media access circuitry 304. In other examples, the example BNN inference pipeline 700 is implemented by both the example memory controller 306, 336 and the example media access circuitry 304, 334. The example BNN inference pipeline 700 includes an example operation selector 702, an example random number generator 704, an example neuron level logic unit 705, an example demultiplexer 707, and an example multiplexer 708. The example operation selector 702 loads the example Bayesian neural network parameters 114 and the example input data 102 to the example SRAM 318 (FIG. 3) from the example data storage 332 (FIG. 3) and/or from the example memory cells 302 of FIG. 3. The example operation selector 702 may select the operation to be executed such as the example tensor operation 706 labeled “random-sample-multiply-add.” The example random number generator 704 creates non-cryptographic level random numbers to be used in tensor operations (e.g., matrix-multiply, determining a maximum value, element-wise non-linear activation functions, etc.). The example neuron level logic unit 705 is substantially similar or identical to the example tensor logic unit 320 (FIG. 3). The example neuron level logic unit 705 applies an example tensor operation 706 (shown as Tᵢ(x)) on the example input data 102. For example, the example neuron level logic unit 705 utilizes an example tensor operation 706, labeled “random-sample-multiply-add.” The example tensor operation 706 utilizes the random number generator 704 to sample weights from the example distribution 112 (FIGS. 1A and 1B) described by the example distribution parameters 114, multiply a selected weight (e.g., the selected weights 111, 113 of FIG. 1B, resultant weight, result, etc.) with the example input data 102 and/or hidden layer data (e.g., first transformed product of a first hidden layer), and then accumulate (e.g., add) the multiplied results (e.g., products) as needed. The example tensor operation 706 is performed in one step, and the example sampled weights are not stored in memory, but sampled from example Bayesian neural network parameters loaded in a multiply-accumulate register, before being multiplied with the data in the example data register 512 (FIG. 5). The example neuron level logic unit 705 then applies the operation that was selected by the operation selector 702 (e.g., RSMA). The example demultiplexer 707 routes the multiplied results (e.g., hidden layer data) to the corresponding Matrix C (from FIG. 5) in the registers 710. The example multiplexer 708 determines where to route the hidden layer data. The example multiplexer 708 may reuse the hidden layer data in another operation (e.g., at a subsequent hidden layer) and route the hidden layer data back to the example operation selector 702. The example multiplexer 708 may store the hidden layer data in SRAM 318. If the hidden layer data is determined to be the iteration result, the example multiplexer may store the result in memory cells 302. The example result 1 712a, result 2 712b refer to different results from tensor operations, such that if there are ten tensor nodes (e.g., ten neurons in a hidden layer), ten results are generated. In other examples, the example result 1 712a, and result 2 712b refer to different results (e.g., hidden layer data) generated at respective clusters, such that if there are five clusters, five results are generated. In other examples, the neuron level logic unit 705 performs an example element-wise non-linear activation function (e.g., sigmoid, tanh, ReLU, etc.) to the multiplied results, and the example demultiplexer 707 routes the transformed results to the corresponding example scratchpads 512, 514, 516 (FIG. 5) (e.g., the example operation data register 512, the example multiply-accumulate register 514, and the example output register 516) of the SRAM 318 (FIG. 3). If there is another hidden layer (e.g., a second hidden layer 109) in the example Bayesian neural network 100, the example multiplexer 708 determines which intermediate results 710 to route to the example operation selection mechanism 702 to be used in the next hidden layer (e.g., a second hidden layer 109). If there are no more hidden layers, the example multiplexer determines where to store the completed results 712. Subsequently, the example completed results 712 are transferred to the example host memory 370 (FIG. 3) or stored in the example device 300 (FIG. 3) in either the data storage device 330 (FIG. 3) or the example memory 310 (FIG. 3). In some examples, the example completed results 712 are combined to create a single aggregated result that contains a probability density function containing the example answer and an example uncertainty.

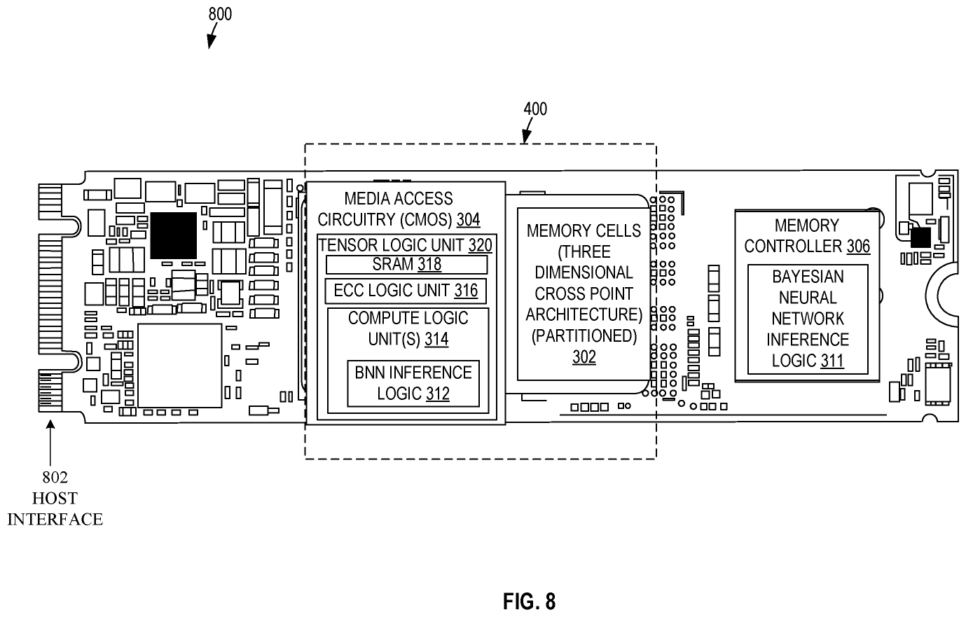

FIGS. 8-10 are a schematic illustrations of example daughter boards that may be used to implement the memory 310 and/or the data storage device 330 of FIG. 3 separate from the example processor 301 of FIG. 3. The example daughter boards implement an example accelerator device to implement BNNs in accordance with teachings of this disclosure. In this manner, a host processor (e.g., the processor 301 of FIG. 3) can offload BNN processes onto a daughter board. By offloading such processes, the host processor is freed up to perform other operations. In addition, the daughter board can perform the BNN processes faster than the host CPU.

The example daughter board 800 of FIG. 8 is based on Intel Optane® memory, in which the example media access circuitry 304 and example memory cells 302 are formed on the same substrate (e.g., the semiconductor substrate 400 of FIG. 4). Forming the example media access circuitry 304 and the example memory cells 302 on the same substrate 400 allows the example daughter board 800 to implement Bayesian neural network inference without decreased performance of prior techniques resulting from multiple off-chip memory reads, off-chip memory writes, and calculations by the example CPU 301. The example media access circuitry 304 is able to perform the matrix operations (e.g., tensor calculations, or matrix-matrix multiply-adds) saving intermediate results in the example SRAM 318, while the example memory cells 302 are able to be addressable at the individual byte level when accessing data. In some examples, the memory cells 302 are addressable at the individual bit level when accessing data. In the example of FIG. 8, results can be sent to the processor 301 via an example host interface 802.

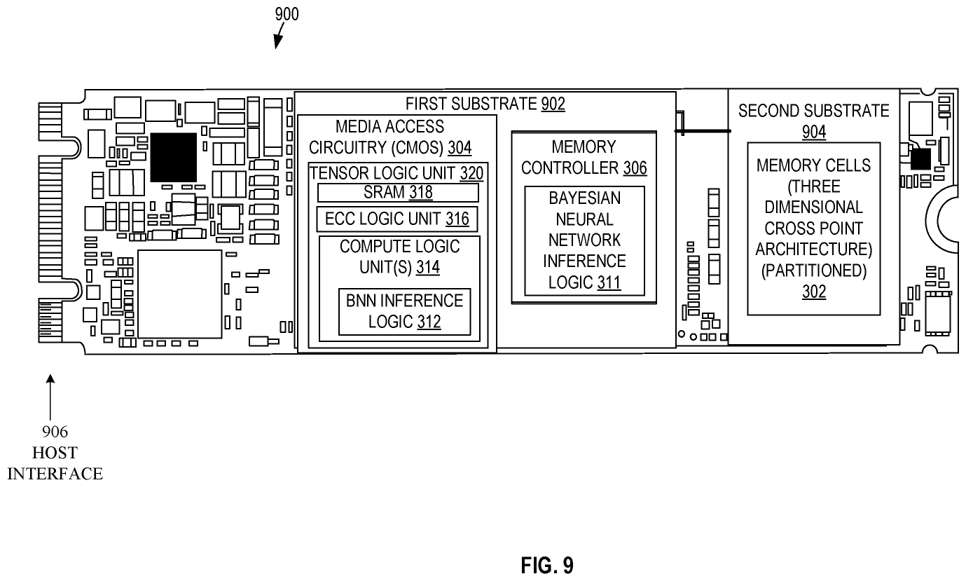

FIG. 9 is a schematic illustration of an alternative example daughter board 900 that may be used to implement the memory 310 and/or data storage device 330 of FIG. 3 separate from the example host processor 301 of FIG. 3. In FIG. 9, an example first substrate 902 contains the example media access circuitry 304 and the example memory controller 306. Also in FIG. 9, an example second substrate 904 contains the example memory cells 302. The example daughterboard 900 is a device to implement a BNN inference and send example results to the processor 301 via an example host interface 906. The example daughterboard 900 may be used to increase communication speed between the example media access circuitry 304 and the example memory controller 306.

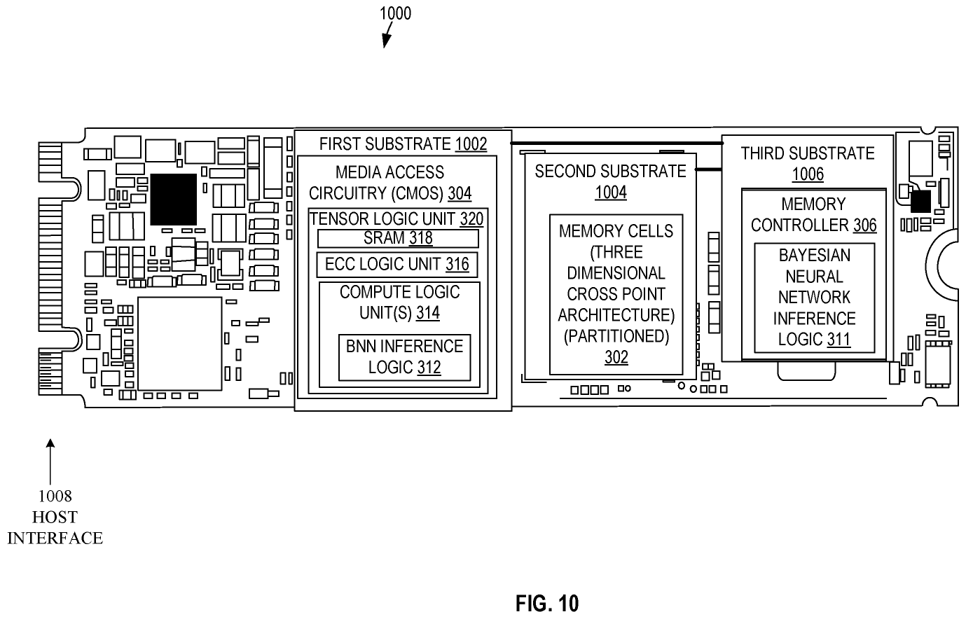

FIG. 10 is a schematic illustration of an alternative example daughter board 1000 that may be used to implement the memory 310 and/or data storage device 330 of FIG. 3 separate from the example processor 301 of FIG. 3. In FIG. 10, an example first substrate 1002 contains the example media access circuitry 304, and an example second substrate 1004 contains the example memory cells 302, and an example third substrate 1006 contains the example memory controller 306. The example third substrate 1006, the example first substrate 1002, and the example second substrate 1004 are in circuit with one another. The example daughterboard 1000 is an implementation of a device to implement a BNN inference and send results to the processor via an example host interface 1008 such that there may be an increase in communication speed between the example first substrate 1002, the example second substrate 1004, and the example third substrate 1006.

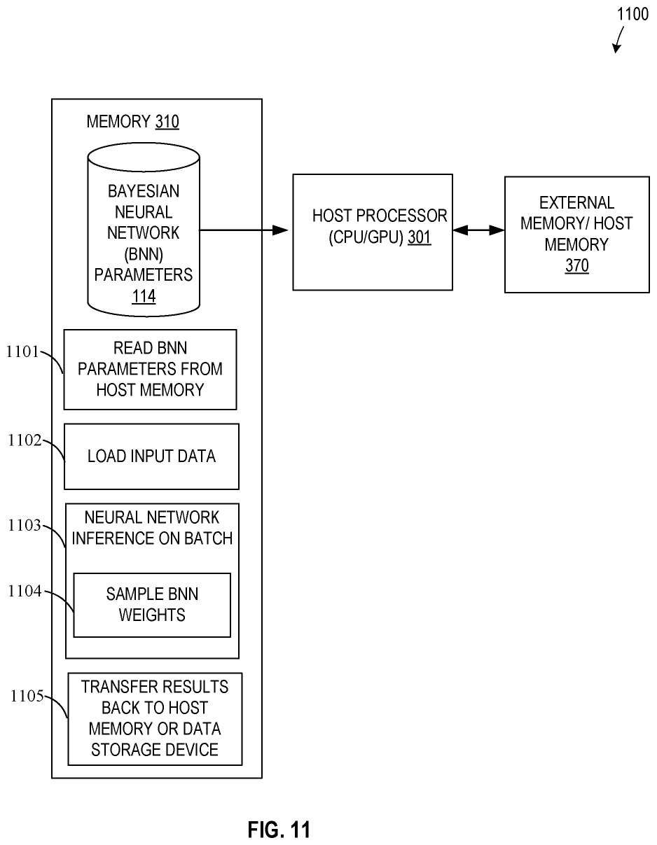

FIG. 11 is an example system 1100 that may be used to implement the example compute device 300 of FIG. 3 based on enumerated operations 1101 through 1105 to implement a Bayesian neural network in accordance with teachings of this disclosure.

In enumerated operation 1101, the example memory controller 306, 336 reads the example BNN parameters 114 from the example memory cells 302. In some examples the example BNN parameters are written from the external memory/host memory 370 to the example memory cells 302 before being read by the example memory controller 306, 336.

At enumerated operation 1102, the example processor 301 loads example input data from the example memory cells 302 (FIG. 3). In other examples, the input data is provided from the example memory/host memory 370 (FIG. 3) or a network interface device (not shown) to the example memory cells 302 (FIG. 3). The example input data is loaded to the SRAM (FIG. 3) in the example operation data register 512 (FIG. 5).

At enumerated operation 1103, the example Bayesian neural network inference logic 311, 312, 341, 342 (FIG. 3) utilizes the example Bayesian neural network parameters 114 loaded in the multiply-accumulate register 514 (FIG. 5) to perform a neural network inference.

At enumerated operation 1104, the example RSMA logic 502 (FIG. 5) utilizes the example Bayesian neural network parameters 114 loaded in the multiply-accumulate register 514 (FIG. 5) that describe a probability distribution of unsampled weights to sample for weights, multiply the example sampled weights 111, 113 most recently sampled by the RSMA logic 502 from the Bayesian neural network parameters 114 loaded in the multiply-accumulate register 514 (FIG. 5) with the input data 102 (e.g., multiply sampled weights by input data values), and accumulate the elements of the matrices.

Returning to enumerated operation 1103, the accumulated matrices (e.g., hidden layer data) then pass an element-wise non-linear activation function, before being sent to the next hidden layer, before an example iteration result is produced. Example operation 1103 is conducted using the example media access circuitry 304 (FIG. 3) and the memory cells 302. The example Bayesian neural network may be executed multiple times (e.g., twenty or any other number) or until a target accuracy is satisfied, which uses multiple samplings of the unsampled weights and multiple inferences on the input data. Each execution of the Bayesian neural network uses a unique sampling of the weights, which typically uses a significant number of memory accesses. Unlike prior techniques that use a significant number of off-chip memory transactions between the CPU 204, the host DRAM 206, and the GPU 208, some examples disclosed herein co-locate the example media access circuitry 304 and the example memory cells 302 in the same semiconductor die or semiconductor substrate (e.g., the semiconductor substrate 400 of FIG. 4) to substantially reduce or eliminate a significant amount of memory transactions. This near-memory configuration enables performing matrix calculations without numerous off-chip data reads and/or writes. For the purposes of this disclosure, “near” is defined as “proximate, adjacent, locationally close.” For example, a near memory is relatively closer (e.g., adjacent or on the same semiconductor substrate or on the same chip or on the same printed circuity board) to a processing device (e.g., a hardware accelerator, logic circuitry, a processor, a controller, etc.) than a far memory which is relatively farther (e.g., on a separate semiconductor substrate on a separate chip or on a separate printed circuit board) from a processing device. In some examples, the example memory cells 302 and the example media access circuitry 304 are able execute the example Bayesian neural network freeing cycles from the example processor 301.

In enumerated operation 1105, the example Bayesian neural network inference logic 311, 312, 341, 342 (FIG. 3) aggregates the iteration results together and sends the completed single final result to example host memory (e.g., the example external memory 370) and/or a storage device (e.g., the example data storage device 330 of FIG. 3 and/or any other data storage device). In some examples, the single final result includes a confidence interval. In some examples, the external memory 370 is volatile memory (e.g., DRAM, SRAM, etc.), and the storage device is non-volatile memory (e.g., 3D cross-point memory, flash memory, magnetic memory, etc.).

In examples disclosed herein, means for loading a neural network parameter value into a register may be implemented by neural network inference logic 311, 312. Also, in examples disclosed herein, means for performing a sample-multiply-add operation on the neural network parameter value and input data to generate a neural network inference result may be implemented by neural network inference logic 311, 312. Also, in examples disclosed herein, means for transferring the neural network inference result to at least one of host memory external to the semiconductor substrate or a host processor external to the semiconductor substrate may be implemented by a memory controller 306. Also, in examples disclosed herein, means for accessing a command from the host processor 301, the command to cause media access circuitry 304 formed on the same semiconductor substrate as the register to initiate a neural network inference pipeline may be implemented by media access circuitry 304. Also, in examples disclosed herein, means for performing a matrix calculation and an element-wise non-linear activation function on the hidden layer data in the local memory to perform the sample-multiply-add operation may be implemented by tensor logic unit 320.

While an example manner of implementing the memory 310 and/or the data storage device 330 is illustrated in FIG. 3, one or more of the elements, processes and/or devices illustrated in FIG. 3 may be combined, divided, re-arranged, omitted, eliminated and/or implemented in any other way. Further, the example media access circuitry 304, 334, the example memory cells 302, 312, the example memory controller 306, 336, the example tensor logic unit 320, 350, the example SRAM 318, 348, the example error correcting logic unit 316, 346, the example compute logic unit 314, 344, the example Bayesian neural network inference logic 311, 312, 341, 342, and/or, more generally, the example memory 310 and/or example data storage device 330 of FIG. 4 may be implemented by hardware, software, firmware and/or any combination of hardware, software and/or firmware. Thus, for example, any of the example media access circuitry 304, 334, the example memory cells 302, 312, the example memory controller 306, 336, the example tensor logic unit 320, the example SRAM 318, 348, the example error correcting logic unit 316, 346, the example compute logic unit 314, 344, the example Bayesian neural network inference logic 311, 312, 341, 342, and/or, more generally, the example memory 310 and/or the example data storage device 330 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, media access circuitry 304, 334, the example memory cells 302, 312, the example memory controller 306, 336, the example tensor logic unit 320, 350, the example SRAM 318, 348, the example error correcting logic unit 316, 346, the example compute logic unit 314, 344, the example Bayesian neural network inference logic 311, 312, 341, 342, and/or, more generally, the example memory 310 and/or the example data storage device 330 of FIG. 4 is/are hereby expressly defined to include a non-transitory computer readable storage device or storage disk such as a memory, a digital versatile disk (DVD), a compact disk (CD), a Blu-ray disk, etc. including the software and/or firmware. Further still, the example memory 310 and/or the example data storage device 330 of FIG. 3 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

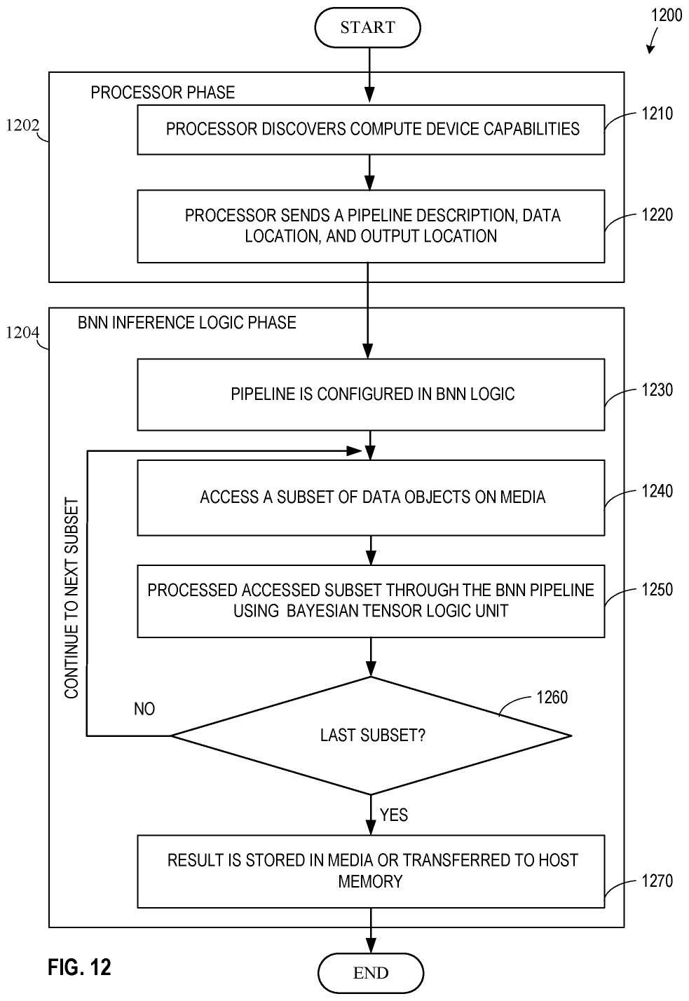

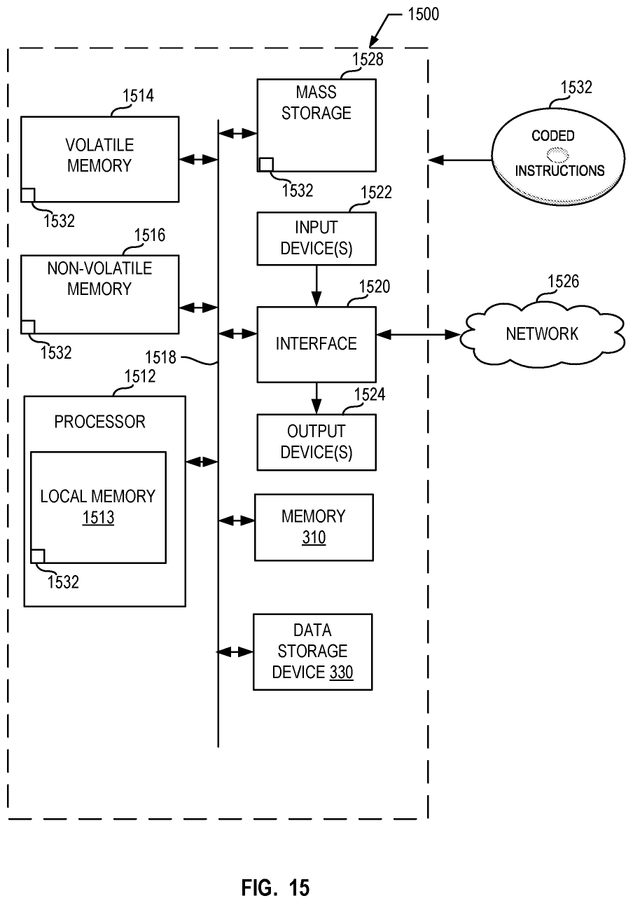

Flowcharts representative of example hardware logic, machine readable instructions, hardware implemented state machines, and/or any combination thereof for implementing the example memory 310 and/or the example data storage device 330 of FIG. 3 are shown in FIGS. 12-14. The machine readable instructions may be one or more executable programs or portion(s) of an executable program for execution by a computer processor and/or processor circuitry, such as the processor 1512 shown in the example processor platform 1500 discussed below in connection with FIG. 15. The program may be embodied in software stored on a non-transitory computer readable storage medium such as a CD-ROM, a floppy disk, a hard drive, a DVD, a Blu-ray disk, or a memory associated with the processor 1512, but the entire program and/or parts thereof could alternatively be executed by a device other than the processor 1512 and/or embodied in firmware or dedicated hardware. Further, although the example program is described with reference to the flowchart illustrated in FIGS. 5, many other methods of implementing the example memory 310 and/or the example data storage device 330 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 12-14 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The example computer readable instructions of FIGS. 12-14 are described in connection with the BNN inference logic 311, 312, 341, 342 in both the memory 310 and the data storage device 330 as performing the BNN inference operations. However, in some examples, the BNN inference logic 311, 312, 341, 342 of only one of the memory 310 or the data storage device 330 may be used.

FIG. 12 is a flowchart representative of machine-readable instructions 1200 that may be executed to implement the Bayesian neural network logic 311, 312, 341, 342 (FIG. 3) to generate a Bayesian neural network. The example instructions 1200 of FIG. 12 are separated into an example processor phase 1202 and an example BNN inference logic phase 1204. Instructions 1200 of the processor phase 1202 may be executed by the example processor 301 of FIG. 3 and/or the example processor 1512 of FIG. 15. Instructions 1200 of the BNN inference logic phase 1204 may be executed by the example media access circuitry 304, 334 (FIG. 3) to implement the BNN inference logic 312, 342 (FIG. 3). Additionally or alternatively, instructions 1200 of the BNN inference logic phase 1204 may be executed by the example memory controller 306, 336 (FIG. 3) to implement the BNN inference logic 311, 341 (FIG. 3).

The example instructions 1200 begin when the example processor 301 discovers compute device capabilities (block 1210). For example, the processor 301 (e.g., a host processor, a CPU, a GPU, etc.) may discover compute device capabilities by sending a query to the example memory 310 and/or the example data storage device 330 requesting capabilities of Bayesian neural network inference logic 311, 312, 341, 342. In the illustrated example, the processor 301 may seek to discover whether any in-circuity devices (e.g., the memory 310 and/or data storage device 330) supports capabilities to implement Bayesian neural networks. For example, as disclosed herein, devices (e.g., the memory 310 and/or the data storage device 330) that include BNN inference logic 311, 312, 341, 342 can support Bayesian neural network capabilities.

The example processor 301 sends a pipeline description, input data location, and output location to the example Bayesian neural network inference logic 311, 312, 341, 342 (block 1220). The example processor 301 may send the example pipeline description, the example input data location, the example output location by providing a memory address corresponding to the example pipeline description, a memory address corresponding to the example input data location, and a memory address corresponding to the example output location.

The BNN inference logic 311, 341, configures the BNN inference pipeline 700 of FIG. 7 (block 1230). For example, the BNN inference logic 311, 341, may configure the BNN inference pipeline 700 (FIG. 7) by developing the topology of the neural network, loading (e.g., storing) the BNN parameters 114 in the multiply-accumulate register 514 (FIG. 5), and selecting activation functions according to the accessed example pipeline description. In some examples the BNN inference logic 312,342 is able to configure the BNN inference pipeline 700.

The example tensor logic unit 320 accesses a subset of data objects of media (block 1240). For example, the example compute device 300 may access a subset of data objects on media by utilizing the example tensor logic unit 320 to access the input data (FIGS. 1A and 7) stored in the memory cells 302, 332 (FIG. 3). Examples of data objects may be pixel data, audio data, sensor data, etc. Additionally or alternatively, if the inference process occurs in the example memory 310 (FIG. 3), the example BNN inference logic 311, 312 may access the input data that is loaded in the 3D cross-point memory (e.g., Intel Optane® memory) or any other suitable memory cells 302. For example, if the inference process occurs in the data storage device 330 (FIG. 3), the example BNN inference logic 341, 342 may access the input data that is loaded in the 3D cross-point memory (e.g., Intel Optane® memory) or any other suitable memory cells 332.

The example tensor logic unit 320 (FIG. 3) of the example media access circuitry 304, 334 processes the example accessed subset of data objects through the BNN inference pipeline 700 (FIG. 7) (block 1250). For example, the tensor logic unit 320 of the example media access circuitry 304, 334 may process the accessed subset of data objects through the BNN inference pipeline 700 (FIG. 7) by utilizing the example compute logic unit 314 (FIG. 3), the example error correcting logic unit 316 (FIG. 3), and the example SRAM 318 (FIG. 3) to randomly sample for weights, and multiply subsets of data with corresponding ones of the sampled weights and store hidden layer data in the example SRAM 318 (FIG. 3). The example BNN inference logic 312, 342 is able to compute the random-sample-multiply-add operation, and transforms the accessed subset using an element-wise non-linear activation function. Example details of how a subset is processed through the example BNN inference pipeline 700 are described above in connection with FIGS. 5 and 7.

The example tensor logic unit 320 determines whether the example subset of data objects processed in block 1250 is the last subset (block 1260). For example, if the example tensor logic unit 320 determines the example subset of data objects processed in block 1250 is not the last subset (e.g., “NO”), control returns to block 1240 to select an additional subset of data objects. For example, if the example tensor logic unit 320 determines the example subset of data objects processed in block 1250 is the last subset of data objects (e.g., “YES”), control advances to block 1270.

The example multiplexer 708 (FIG. 7) of the example BNN inference logic 311, 312, 341, 342 (FIG. 3) stores the result in media or transfers the result to host memory (block 1270). For example, the example multiplexer 708 (FIG. 7) of the example BNN inference logic 311, 312, 341, 342 (FIG. 3) may store the iteration result in memory cells 302 (FIG. 3.) or transfer the results to host memory 370 (FIG. 3) by routing the results according to target output location. In some examples, a post-processing unit (not shown) aggregates the iteration results before sending a final single completed result (e.g., a single final confidence interval) to the memory cells 302 (FIG. 3) or the example host memory 370 (FIG. 3). The example instructions of FIG. 12 end.

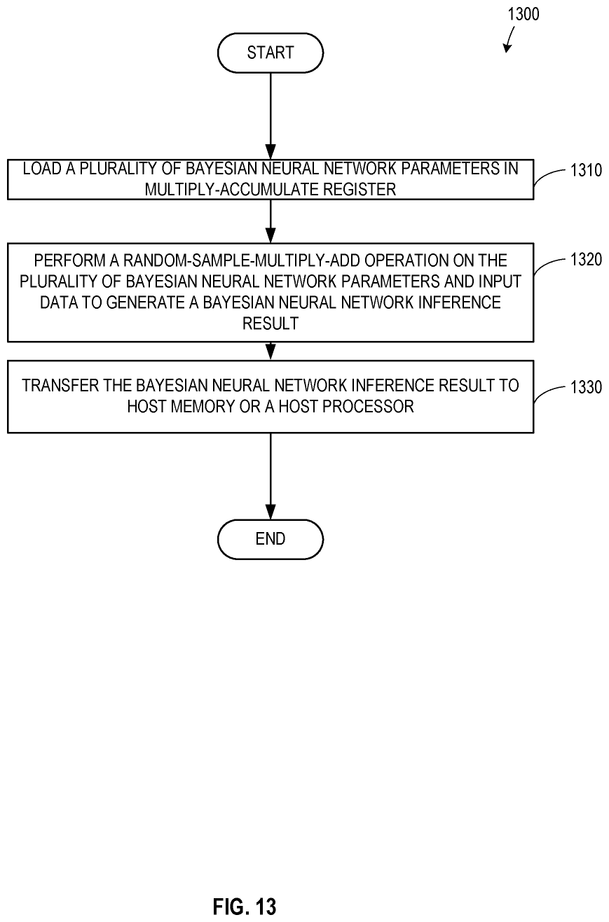

FIG. 13 is a flowchart representative of machine-readable instructions 1300 that may be executed to implement the memory 310 (FIG. 3) to generate a Bayesian neural network.

Additionally or alternatively, the machine-readable instructions 1300 may be executed to implement the data storage device 330 (FIG. 3) to generate a Bayesian neural network.

The Bayesian neural network inference logic 311, 341 (FIG. 3) loads a plurality of Bayesian neural network parameters for in a multiply-accumulate register (block 1310). For example, the Bayesian neural network inference logic 311, 341 in the memory controller 306, 336 controls memory operations to load a plurality of Bayesian neural network parameter values (e.g., the Bayesian neural network parameters 114 of FIGS. 1A and 11)) by accessing the Bayesian neural network parameters from the memory cells 302 (FIG. 3) and loading the Bayesian neural network parameters in the multiply-accumulate register 514 (FIG. 5).

The example BNN inference logic 312, 342 (FIG. 3) performs a random-sample-multiply-add operation based on the plurality of Bayesian neural network parameters 114 (FIGS. 1A and 7) and input data 102 (FIGS. 1A and 7) to generate a Bayesian neural network inference result (block 1320). For example, the example BNN inference logic 312, 342 may perform a random-sample-multiply-add operation on the plurality of Bayesian neural network parameters 114 and input data to generate a Bayesian neural network inference result by randomly sampling for the Bayesian neural network weights with the plurality of Bayesian neural network parameters 114 that are loaded in the example multiply-accumulate register, multiply the sampled weights with input data 102 that is loaded in the example operation data register, and add (e.g., or accumulate) products. In some examples, an example element-wise non-linear activation function is performed on the generated products, before transforming the data for use in the next hidden layer. The example process of block 1320 repeats until a Bayesian neural network inference result is generated.

The example memory controller 306 transfers the Bayesian neural network inference result to host memory or a host processor (block 1330). For example, the example memory controller 306 may transfer the Bayesian neural network inference result (e.g., a first inference iteration result 712a) to host memory (e.g., the example host memory 370 of FIGS. 3 and 11) external to the substrate (e.g., the semiconductor substrate 400 of FIG. 4) or a processor (e.g., the host processor 301 of FIG. 3) external to the substrate by utilizing the example memory controller 306 to route the results to corresponding output data locations. The example instructions of FIG. 13 end.

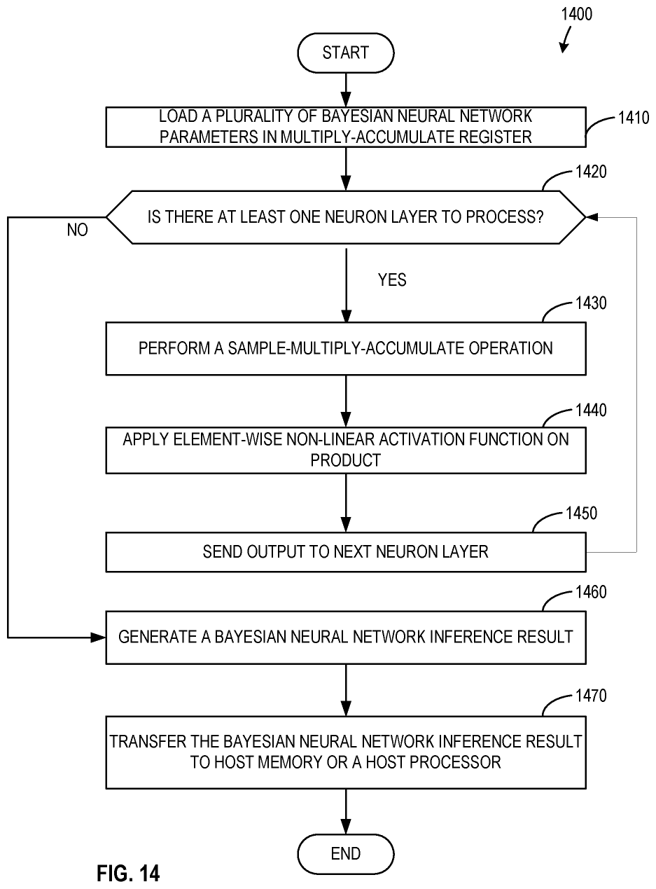

FIG. 14 is a flowchart representative of machine-readable instructions 1400 which may be executed to implement the example memory 310 (FIG. 3) and/or the example data storage device 330 (FIG. 3) to generate a Bayesian neural network. Although the example instructions 1400 are described in connection with components of the example memory 310, the example instructions 1400 may similarly implement components of the example data storage device 330. The example instructions 1400 begin at block 1410 at which the Bayesian neural network inference logic 311, 312 (FIG. 3) loads a plurality of Bayesian neural network parameter values in the multiply-accumulate register. For example, the Bayesian neural network inference logic 311, 312 may load a plurality of Bayesian neural network parameter values (e.g., the Bayesian neural network parameters 114 of FIGS. 1A and 11) by accessing the Bayesian neural network parameters from the memory cells 302 (FIG. 3) and loading the Bayesian neural network parameters in the multiply-accumulate register 514 (FIG. 5).

The BNN inference logic 311, 312 determines if there is at least one neuron layer in the next stages of the Bayesian neural network (block 1420). For example, if the BNN inference logic 311, 312 determines there is at least one neuron layer to process in the example Bayesian neural network (e.g., “YES”), control advances to block 1430. Otherwise, if the BNN inference logic 311, 312 determines there is not at least one neuron layer to process in the example Bayesian neural network (e.g., “NO”), control advances to block 1460.

The example BNN inference logic 312, 342 (FIG. 3) performs a sample-multiply-add operation based on the plurality of Bayesian neural network parameters 114 (FIGS. 1A and 7) and input data 102 (FIGS. 1A and 7) to generate a Bayesian neural network inference result (block 1430). For example, the example BNN inference logic 312, 342 may perform a sample-multiply-add operation on the plurality of Bayesian neural network parameters 114 and input data 102 to generate a Bayesian neural network inference result by randomly sampling for the Bayesian neural network weights based on the plurality of Bayesian neural network parameters 114 that are loaded in the example multiply-accumulate register 514, multiply the sampled weights with input data 102 that is loaded in the example operation data register 512, and accumulate (e.g., or add) the products. A matrix-multiply operation includes multiplying the elements of one row of a matrix with elements of one column of another matrix, and adding or accumulating the results.

The example BNN inference logic 311, 312 applies an element-wise non-linear activation function on the example generated product (e.g., an example hidden layer data 710 of FIG. 7) (block 1440). The example BNN inference logic 311, 312 may perform the element-wise non-linear activation function 118 as described above in connection with FIG. 1A to transform the generated product into a constrained value. For example, the element-wise non-linear activation function 118 could be tanh, sigmoid, or a rectified linear unit test.

At block 1450, the example BNN inference logic 311, 312 sends the product (e.g., example hidden layer data or an example result 712 of FIG. 7) to the next neuron layer. For example, the example BNN inference logic 312 may send the product (e.g., example hidden layer data, the example transformed product) to the next neuron layer (e.g., the second hidden layer 108 of FIG. 1A) by loading the product to the corresponding neuron in the next neuron layer such as the operation data register 512 (FIG. 5). Control returns to block 1420 to determine if there is at least another neuron layer to process.

When the example BNN inference logic 311, 312 determines at block 1420 that there is not another neuron layer to process, the example BNN inference logic 311, 312 generates a Bayesian neural network inference result at the output neuron (block 1460).

The example BNN inference logic 311, 312 generates a Bayesian neural network inference result by performing a Bayesian neural network inference on input data using the plurality of sampled Bayesian neural network weights (block 1460). For example, the example BNN inference logic 311, 312 may generate a Bayesian neural network inference result (e.g., a result 712 of FIG. 7) by aggregating the results generated at different iterations through the example BNN inference pipeline 700.

The example memory controller 306 (FIG. 3) transfers the Bayesian neural network inference result to host memory or a host processor (block 1470). For example, the example memory controller 306 may transfer the Bayesian neural network inference result to host memory (e.g., the example host memory 370 of FIGS. 3 and 11) external to the substrate (e.g., the semiconductor substrate 400 of FIG. 4) or a host processor (e.g., the host processor 301 of FIG. 3) external to the substrate. The example instructions of FIG. 14 end.

FIG. 15 is a block diagram of an example processor platform 1500 structured to execute the instructions of FIGS. 12-14 to implement the apparatus of FIG. 3. The processor platform 1500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1500 of the illustrated example includes a processor 1512. The processor 1512 of the illustrated example is hardware. For example, the processor 1512 can be implemented by one or more integrated circuits, logic circuits, microprocessors, GPUs, DSPs, or controllers from any desired family or manufacturer. The hardware processor may be a semiconductor based (e.g., silicon based) device. In some examples, the processor 1512 implements the processor 301 of FIG. 3.

The processor 1512 of the illustrated example includes a local memory 1513 (e.g., a cache). The processor 1512 of the illustrated example is in communication with a main memory including a volatile memory 1514 and a non-volatile memory 1516 via a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®) and/or any other type of random access memory device. In some examples, the volatile memory 1514 implements the host memory 370 (FIG. 3). The non-volatile memory 1516 may be implemented by flash memory and/or any other desired type of memory device. Access to the main memory 1514, 1516 is controlled by a memory controller.

The processor platform 1500 of the illustrated example also includes an interface circuit 1520. The interface circuit 1520 may be implemented by any type of interface standard, such as an Ethernet interface, a universal serial bus (USB), a Bluetooth® interface, a near field communication (NFC) interface, and/or a PCI express interface.

In the illustrated example, one or more input devices 1522 are connected to the interface circuit 1520. The input device(s) 1522 permit(s) a user to enter data and/or commands into the processor 1512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1524 are also connected to the interface circuit 1520 of the illustrated example. The output devices 1524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1520 of the illustrated example, thus, typically includes a graphics driver card, a graphics driver chip and/or a graphics driver processor.

The interface circuit 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1500 of the illustrated example also includes one or more mass storage devices 1528 for storing software and/or data. Examples of such mass storage devices 1528 include floppy disk drives, hard drive disks, compact disk drives, Blu-ray disk drives, redundant array of independent disks (RAID) systems, and digital versatile disk (DVD) drives.

Machine executable instructions 1532 represented in FIGS. 12-14 may be stored in the mass storage device 1528, in the volatile memory 1514, in the non-volatile memory 1516, and/or on a removable non-transitory computer readable storage medium such as a CD or DVD.

In the example of FIG. 15, memory 310 (FIG. 3) and the data storage device 330 (FIG. 3) are in circuit with the bus 1518.

From the foregoing, it will be appreciated that example methods, apparatus and articles of manufacture have been disclosed that implement a Bayesian neural network. The disclosed methods, apparatus and articles of manufacture improve the efficiency of using a computing device by running a Bayesian neural network on an apparatus external to the host processor such that the host processor is free to perform other calculations, the apparatus including memory cells, media access circuitry and Bayesian neural network inference logic. The disclosed methods, apparatus and articles of manufacture are accordingly directed to one or more improvement(s) in the functioning of a computer.

Example methods, apparatus, systems, and articles of manufacture to implement a Bayesian neural network are disclosed herein. Further examples and combinations thereof include the following: Example 1 includes an apparatus to implement a neural network, the apparatus comprising memory formed on a substrate, neural network inference logic formed on the same substrate as the memory, the neural network inference logic to load a neural network parameter value in a register, and perform a sample-multiply-add operation on the neural network parameter value and input data to generate a neural network inference result, and a memory controller to transfer the neural network inference result to at least one of host memory external to the substrate or a host processor external to the substrate.

Example 2 includes the apparatus of example 1, further including media access circuitry, the media access circuitry in circuit with the memory, the media access circuitry formed on the same substrate as the memory and the neural network inference logic, the media access circuitry including the register to receive the neural network parameter value from the memory.

Example 3 includes the apparatus of example 1, further including media access circuitry to access a command from the host processor, the command to cause the media access circuitry to initiate a neural network inference pipeline.

Example 4 includes the apparatus of example 1, wherein the neural network inference logic is formed using a complementary metal-oxide-semiconductor on a first layer of the substrate, the first layer adjacent a second layer of the substrate that includes the memory.

Example 5 includes the apparatus of example 1, wherein the memory is three-dimensional cross-point memory.

Example 6 includes the apparatus of example 1, wherein the host processor is a graphics processing unit.

Example 7 includes the apparatus of example 1, further including media access circuitry and local memory in the media access circuitry, the neural network inference logic to generate the neural network inference result based on generating hidden layer data in the local memory, and providing the hidden layer data through a neural network inference pipeline.

Example 8 includes the apparatus of example 7, wherein the memory is nonvolatile memory and the local memory is volatile memory.

Example 9 includes the apparatus of example 7, further including tensor logic to perform a matrix calculation and an element-wise non-linear activation function on the hidden layer data in the local memory to perform the sample-multiply-add operation.

Example 10 includes the apparatus of example 9, wherein the element-wise non-linear activation function is at least one of a sigmoid function, a tanh function, or a ReLU function.

Example 11 includes a non-transitory computer readable storage medium, comprising computer readable instructions that, when executed, cause one or more processors to, at least load a neural network parameter value from memory formed on a semiconductor substrate to a register of neural network inference logic formed on the same semiconductor substrate, and perform a sample-multiply-add operation on the neural network parameter value and input data to generate a neural network inference result, and transfer the neural network inference result to at least one of host memory external to the semiconductor substrate or a host processor external to the semiconductor substrate.

Example 12 includes the non-transitory computer readable medium of example 11, wherein the instructions are to cause the one or more processors to access a command from the host processor, the command to cause media access circuitry formed on the same semiconductor substrate to initiate a neural network inference pipeline.

Example 13 includes the non-transitory computer readable medium of example 11, wherein the memory is three-dimensional cross-point memory.

Example 14 includes the non-transitory computer readable medium of example 11, wherein the host processor is a graphic processing unit.

Example 15 includes the non-transitory computer readable medium of example 11, wherein the instructions are to cause the one or more processors to generate the neural network inference result based on generating hidden layer data in a local memory of media access circuitry formed on the same semiconductor substrate, and providing the hidden layer data through a neural network inference pipeline.

Example 16 includes the non-transitory computer readable medium of example 15, wherein the memory is nonvolatile memory and the local memory is volatile memory.

Example 17 includes the non-transitory computer readable medium of example 15, wherein the instructions are to cause the one or more processors to perform matrix calculations and element-wise non-linear activation functions on the hidden layer data in the local memory to perform the sample-multiply-add operation.

Example 18 includes the non-transitory computer readable medium of example 17, wherein the element-wise non-linear activation function is at least one of a sigmoid function, a tanh function, or a ReLU function.

Example 19 includes a method to implement a neural network, the method comprising loading a neural network parameter value in a register formed on a semiconductor substrate from memory formed on the same semiconductor substrate, performing a sample-multiply-add operation on the neural network parameter value and input data to generate a neural network inference result, and transferring the neural network inference result to at least one of host memory external to the semiconductor substrate or a host processor external to the semiconductor substrate.

Example 20 includes the method of example 19, further including accessing a command from the host processor, the command to cause media access circuitry formed on the same semiconductor substrate as the register to initiate a neural network inference pipeline.

Example 21 includes the method of example 19, wherein the memory is three-dimensional cross-point memory.

Example 22 includes the method of example 19, wherein the host processor is a graphics processing unit.

Example 23 includes the method of example 19, wherein the generating of the neural network inference result is based on generating hidden layer data in a local memory formed on the same semiconductor substrate, and providing the hidden layer data through a neural network inference pipeline.

Example 24 includes the method of example 23, wherein the memory is nonvolatile memory and the local memory is volatile memory.

Example 25 includes the method of example 23, further including performing a matrix calculation and an element-wise non-linear activation function on the hidden layer data in the local memory to perform the sample-multiply-add operation.

Example 26 includes the method of example 25, wherein the element-wise non-linear activation function is at least one of a sigmoid function, a tanh function, or a ReLU function.

Example 27 includes an apparatus to implement a neural network, the apparatus comprising means for loading a neural network parameter value into a register formed on a semiconductor substrate, the neural network parameter value stored in memory formed on the same semiconductor substrate, means for performing a sample-multiply-add operation on the neural network parameter value and input data to generate a neural network inference result, and means for transferring the neural network inference result to at least one of host memory external to the semiconductor substrate or a host processor external to the semiconductor substrate.

Example 28 includes the apparatus of example 27, further including means for accessing a command from the host processor, the command to cause media access circuitry formed on the same semiconductor substrate as the register to initiate a neural network inference pipeline.

Example 29 includes the apparatus of example 27, wherein the memory is three-dimensional cross-point memory.

Example 30 includes the apparatus of example 27, wherein the host processor is a graphics processing unit.

Example 31 includes the apparatus of example 27, wherein the neural network inference result is based on hidden layer data in a local memory formed on the same semiconductor substrate, and a neural network inference pipeline on the same semiconductor substrate.

Example 32 includes the apparatus of example 31, wherein the memory is nonvolatile memory and the local memory is volatile memory.

Example 33 includes the apparatus of example 31, further including means for performing a matrix calculation and an element-wise non-linear activation function on the hidden layer data in the local memory to perform the sample-multiply-add operation.

Example 34 includes the apparatus of example 33, wherein the element-wise non-linear activation function is at least one of a sigmoid function, a tanh function, or a ReLU function. Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus to implement a neural network, the apparatus comprising:
memory formed on a substrate;
neural network inference logic formed on the same substrate as the memory, the neural network inference logic to:
load a neural network parameter value in a register; and
perform a sample-multiply-add operation on the neural network parameter value and input data to generate a neural network inference result; and
a memory controller to transfer the neural network inference result to at least one of host memory external to the substrate or a host processor external to the substrate.

2. The apparatus of claim 1, further including media access circuitry, the media access circuitry in circuit with the memory, the media access circuitry formed on the same substrate as the memory and the neural network inference logic, the media access circuitry including the register to receive the neural network parameter value from the memory.

3. The apparatus of claim 1, further including media access circuitry to access a command from the host processor, the command to cause the media access circuitry to initiate a neural network inference pipeline.

4. The apparatus of claim 1, wherein the neural network inference logic is formed using a complementary metal-oxide-semiconductor on a first layer of the substrate, the first layer adjacent a second layer of the substrate that includes the memory.

5. The apparatus of claim 1, wherein the memory is three-dimensional cross-point memory.

6. The apparatus of claim 1, wherein the host processor is a graphics processing unit.

7. The apparatus of claim 1, further including media access circuitry and local memory in the media access circuitry, the neural network inference logic to generate the neural network inference result based on generating hidden layer data in the local memory, and providing the hidden layer data through a neural network inference pipeline.

8. The apparatus of claim 7, wherein the memory is nonvolatile memory and the local memory is volatile memory.

9. The apparatus of claim 7, further including tensor logic to perform a matrix calculation and an element-wise non-linear activation function on the hidden layer data in the local memory to perform the sample-multiply-add operation.

10. The apparatus of claim 9, wherein the element-wise non-linear activation function is at least one of a sigmoid function, a tanh function, or a ReLU function.

11. A non-transitory computer readable storage medium, comprising computer readable instructions that, when executed, cause one or more processors to, at least:
load a neural network parameter value from memory formed on a semiconductor substrate to a register of neural network inference logic formed on the same semiconductor substrate; and
perform a sample-multiply-add operation on the neural network parameter value and input data to generate a neural network inference result; and
transfer the neural network inference result to at least one of host memory external to the semiconductor substrate or a host processor external to the semiconductor substrate.

12. The non-transitory computer readable medium of claim 11, wherein the instructions are to cause the one or more processors to access a command from the host processor, the command to cause media access circuitry formed on the same semiconductor substrate to initiate a neural network inference pipeline.

13. The non-transitory computer readable medium of claim 11, wherein the memory is three-dimensional cross-point memory.

14. The non-transitory computer readable medium of claim 11, wherein the host processor is a graphic processing unit.

15. The non-transitory computer readable medium of claim 11, wherein the instructions are to cause the one or more processors to generate the neural network inference result based on:
generating hidden layer data in a local memory of media access circuitry formed on the same semiconductor substrate; and
providing the hidden layer data through a neural network inference pipeline.

16. The non-transitory computer readable medium of claim 15, wherein the memory is nonvolatile memory and the local memory is volatile memory.

17. The non-transitory computer readable medium of claim 15, wherein the instructions are to cause the one or more processors to perform a matrix calculation and an element-wise non-linear activation function on the hidden layer data in the local memory to perform the sample-multiply-add operation.

18. The non-transitory computer readable medium of claim 17, wherein the element-wise non-linear activation function is at least one of a sigmoid function, a tanh function, or a ReLU function.

19. A method to implement a neural network, the method comprising:
loading a neural network parameter value in a register formed on a semiconductor substrate from memory formed on the same semiconductor substrate;
performing a sample-multiply-add operation on the neural network parameter value and input data to generate a neural network inference result; and
transferring the neural network inference result to at least one of host memory external to the semiconductor substrate or a host processor external to the semiconductor substrate.

20. The method of claim 19, further including accessing a command from the host processor, the command to cause media access circuitry formed on the same semiconductor substrate as the register to initiate a neural network inference pipeline.

21. The method of claim 19, wherein the memory is three-dimensional cross-point memory.

22. The method of claim 19, wherein the host processor is a graphics processing unit.

23. The method of claim 19, wherein the generating of the neural network inference result is based on generating hidden layer data in a local memory formed on the same semiconductor substrate, and providing the hidden layer data through a neural network inference pipeline.

24. The method of claim 23, wherein the memory is nonvolatile memory and the local memory is volatile memory.

25. The method of claim 23, further including performing a matrix calculation and an element-wise non-linear activation function on the hidden layer data in the local memory to perform the sample-multiply-add operation.

26-34. (canceled)
